(19) United States
(12) Patent Application Publication
(10) Pub. No.: US 2009/0184622 A1
(43) Pub. Date: Jul. 23, 2009

(54) LAMP AND DISPLAY DEVICE HAVING THE SAME

(75) Inventors: Dong-Chin LEE, Cheonan-si (KR); Seok-Hyun NAM, Seoul (KR); Seon-Bae KIM, Asan-si (KR); Min-Jeong WANG, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/243,523

(22) Filed: Oct. 1, 2008

(30) Foreign Application Priority Data
Jan. 22, 2008 (KR) 10-2008-006734

(51) Int. Cl. H01J 1/62

(52) U.S. Cl. 313/485

(57) ABSTRACT

A lamp and a display device including the lamp, in which the lamp includes a discharge tube, a discharge gas, a blue fluorescent substance, a green fluorescent substance and a red fluorescent substance. The discharge gas is disposed in the discharge tube. The blue, green and red fluorescent substances are disposed at an inner wall surface of the discharge tube to generate a blue light, a green light and a red light by ultraviolet rays emitted by the discharge gas. The red fluorescent substance includes at least two different red fluorescent substances, which generate the red light having peak wavelengths different from each other. Thus, the color reproducibility may be improved using the two different red fluorescent substances.

This application claims priority to Korean Patent Application No. 2008-6734 filed on Jan. 22, 2008, and all the benefits accruing therefrom under 35 U.S.C. §119, the contents of which in its entirety are herein incorporated by reference.

### BACKGROUND OF THE INVENTION

1. Field of the Invention

The present invention relates to a lamp and a display device having the same. More particularly, the present invention relates to a lamp having improved color reproducibility and a display device having the lamp.

2. Description of the Related Art

In general, a liquid crystal display (“LCD”) includes a liquid crystal panel and a backlight unit in order to display an image. The LCD receives an external data signal to display an image according to electrical and optical characteristics of liquid crystals in the liquid crystal panel. The backlight unit generates light, which provides light to the liquid crystal panel. As a result, the light provided to the liquid crystal panel passes through the liquid crystals, so that an image is displayed on the liquid crystal panel.

The backlight unit typically includes light sources and optical sheets. The light source may include a light emitting diode (“LED”) or a lamp. For example, in the case of a conventional large-size LCD, a plurality of lamps is used as the light source and the lamps are aligned to emit light having increased brightness.

The conventional large-size LCD comprises 72% of color reproducibility in accordance with the National Television System Committee (“NTSC”). Typically, the color reproducibility varies depending on the type of fluorescent substance of a lamp used for the LCD. For example, if the lamp, which generates light having a wavelength corresponding to the type of fluorescent substance, generates light that is not suitable for a transmission spectrum of a color filter, the color reproducibility is lowered.

Thus, it is desired to develop a lamp capable of having improved color reproducibility for the LCD and a display device having the same.

### BRIEF SUMMARY OF THE INVENTION

An exemplary embodiment of the present invention provides a lamp having improved color reproducibility by using at least two different mixed red fluorescent substances.

Another exemplary embodiment of the present invention provides a display device including the lamp having improved color reproducibility by using at least two different mixed red fluorescent substances.

In an exemplary embodiment of the present invention, a lamp, for a backlight unit of a display panel in a display device, includes a discharge tube, a discharge gas, a blue fluorescent substance, a green fluorescent substance and a red fluorescent substance. The discharge gas is disposed in the discharge tube. The blue, green and red fluorescent substances are disposed at an inner wall surface of the discharge tube to generate a blue light, a green light and a red light, respectively, by ultraviolet rays emitted by the discharge gas. The red fluorescent substance includes at least two different red fluorescent substances, which generate the red light having peak wavelengths different from each other.

In another exemplary embodiment of the present invention, a display device includes a display panel and a backlight unit. The backlight unit includes at least one lamp to emit light to the display panel. The lamp includes a discharge tube, a discharge gas, a blue fluorescent substance, a green fluorescent substance and a red fluorescent substance. The discharge gas is disposed in the discharge tube. The blue, green and red fluorescent substances are disposed at an inner wall surface of the discharge tube to generate a blue light, a green light and a red light by ultraviolet rays emitted by the discharge gas. The red fluorescent substance includes at least two different red fluorescent substances, which generate the red light having peak wavelengths different from each other.

The display panel includes first and second substrates, and a color filter disposed at the first substrate or the second substrate.

The color filter has a thickness of about 1.5 μm to about 2 μm and includes blue, green and red filters. The blue color filter allows light having a wavelength range of 400 nm to 530 nm to pass therethrough. The green color filter allows light having a wavelength range of about 460 nm to about 600 nm to pass therethrough. The red color filter allows light having a wavelength range of about 580 nm to about 800 nm to pass therethrough. The red fluorescent substance generates the red light having a wavelength range of about 600 nm to about 680 nm. The red fluorescent substance includes compounds Y₂O:Eu³⁺ and 3.5MgO.0.5MgF₂.GeO₂:Mn⁴⁺. The red fluorescent substance includes the Y₂O:Eu³⁺ having 60% composition weight to 90% composition weight and the 3.5MgO.0.5MgF₂.GeO₂:Mn⁴⁻ having 10% composition weight to 40% composition weight. The blue fluorescent substance includes compound (Sr, Ca, Ba, Mg)₅(PO4)₃CL:Eu²⁺. The green fluorescent substance includes compound BaMaAl₁₀O₁₇:Eu₂+,Mn²⁺.

The backlight unit includes a plurality of lamps. In an exemplary embodiment, the lamps are disposed below the display panel, but is not limited thereto. The display device further includes an optical sheet section and a reflective sheet. The optical sheet section is disposed between the lamps and the display panel. The reflective sheet is disposed below the lamps. The backlight unit further includes a light guide plate disposed below the display panel. In another exemplary embodiment, a single lamp may be disposed at a lateral side of the light guide plate. The display device further includes an optical sheet section and a reflective sheet. The optical sheet section is disposed between the display panel and the light guide plate, and the reflective sheet is disposed below the light guide plate.

In yet another exemplary embodiment of the present invention, a method for improving color reproducibility in a lamp of a display device is provided. The method includes emitting light from the lamp to a display panel of the display device; emitting a blue light and a green light from a blue fluorescent substance and a green fluorescent substance, respectively, by ultraviolet rays by an excited discharge gas; emitting a red light comprising peak wavelengths different from each other from two different red fluorescent substances; transmitting light comprising a wavelength range of about 400 nm to about 530 nm through a blue color filter; transmitting light comprising a wavelength range of about 460 nm to about 600 nm through a green color filter; and transmitting light comprising a wavelength range of about 580 nm to about 800 nm through a red color filter.

Accordingly, color reproducibility may be improved using two types of red fluorescent substances. Further, the lamp of the display device uses two types of red fluorescent substances, so that the red color of the display device may be clearly displayed.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is an exploded perspective view illustrating a liquid crystal display (“LCD”) according to an exemplary embodiment of the present invention;

FIG. 2 is an enlarged plan view illustrating a portion of a liquid crystal panel shown in FIG. 1;

FIG. 3 is a cross sectional view taken along line I-I′ of the liquid crystal panel shown in FIG. 2;

FIG. 4 is a graph illustrating a transmission spectrum of a color filter shown in FIG. 3;

FIG. 5 is a cross sectional view illustrating a lamp shown in FIG. 1;

FIGS. 6 to 9 are graphs illustrating spectra of light according to a mixture ratio of compounds YOX and MFG;

FIGS. 10 and 11 are color coordinates illustrating color reproducibility of a lamp in accordance with the International Commission on Illumination (CIE) according to an exemplary embodiment of the present invention; and

FIG. 12 is an exploded perspective view illustrating an LCD having a lateral-type backlight unit according to an exemplary embodiment of the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

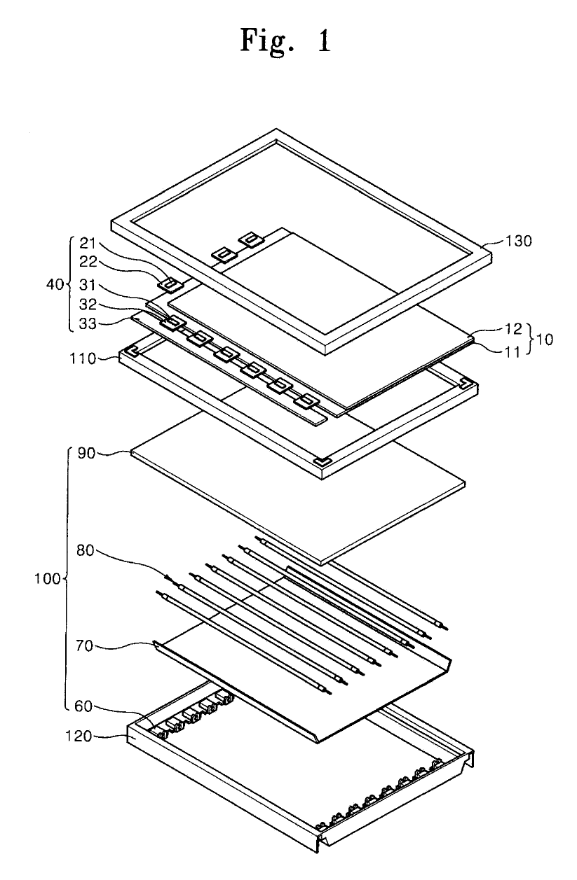

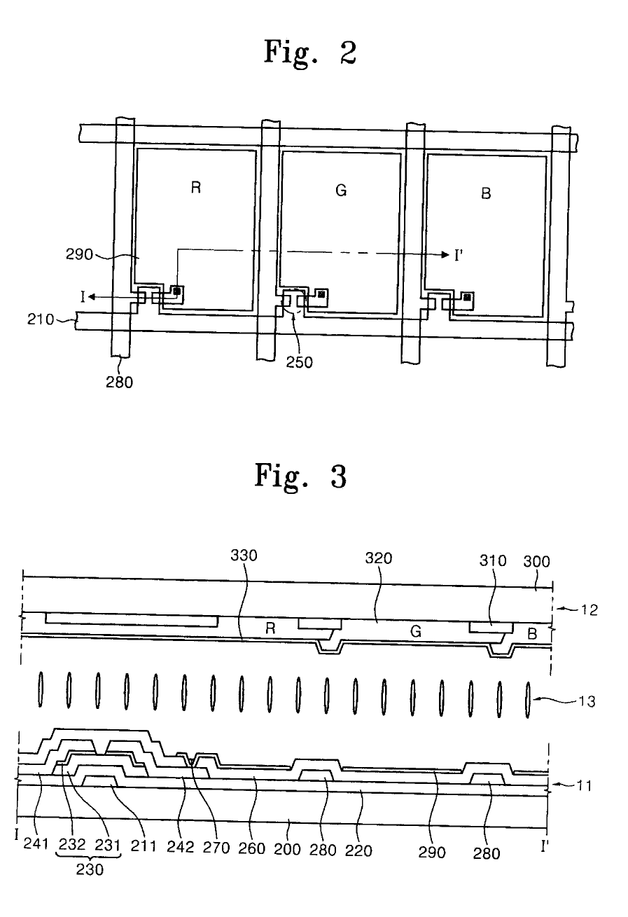

FIG. 1 is an exploded perspective view illustrating an LCD according to an exemplary embodiment of the present invention, FIG. 2 is an enlarged plan view illustrating a portion of a liquid crystal panel of the LCD shown in FIG. 1, and FIG. 3 is a cross sectional view taken along line I-I′ of the liquid crystal panel shown in FIG. 2.

Referring to FIGS. 1 to 3, the LCD includes a liquid crystal panel 10, a panel driving unit 40 and a backlight unit 100.

In further detail, the liquid crystal panel 10 includes a first substrate 11, a second substrate 12 and liquid crystals 13 which are interposed between the first substrate 11 and second substrate 12. The first substrate 11 comprises a thin film transistor array and, as illustrated in FIG. 2, includes gate lines 210, data lines 280, thin film transistors 250 and pixel electrodes 290, which are formed on a first insulating substrate 200, as illustrated in FIG. 3. The second substrate 12 comprises a color filter array. The gate lines 210 of the first substrate 11 cross the data lines 280 on the first insulating substrate 200. Further, the gate lines 210 of the first substrate 11 are insulated from the data lines 280 by a gate insulating layer 220.

Referring again to FIG. 3, the thin film transistor 250 includes a gate electrode 211, an active layer 230, a source electrode 241 and a drain electrode 242. The gate electrode 211 of the thin film transistor 250 protrudes from the gate lines 210 to drive the thin film transistor 250 according to a gate on/off voltage applied from the gate lines 210. The active layer 230 overlaps the gate electrode 211 with the gate insulating layer 220. The active layer 230 includes a semiconductor layer 231 and an ohmic contact layer 232 and forms a channel of the thin film transistor 250.

Still referring the FIG. 3, the source electrode 241 is formed on the active layer 230 while being connected with the data lines 280. The drain electrode 242 is also formed on the active layer 230 while facing the source electrode 241.

The pixel electrodes 290 are connected with the drain electrode 242 through a contact hole 270 that passes through a protective layer 260. Thus, when the thin film transistor 250 is turned on, the pixel electrodes 290 form an electric field through data voltage applied from the data lines 280 together with a common electrode 330.

The liquid crystals 13 interposed between the first substrate 11 and second substrate 12 of the liquid crystal panel 10, as shown in FIG. 3, are aligned to emit light. For example, the liquid crystals 13 of the liquid crystal panel 10 may be aligned in a twisted nematic (“TN”) mode, a vertical alignment (“VA”) mode and the like. When the liquid crystals 13 are aligned in the TN mode, a domain division device, for example, a slit or a protrusion, may be formed in the pixel electrodes 290 and the common electrode 330. The liquid crystals 13 include material having a dielectric anisotropy and are driven by the electric field formed between the pixel electrodes 290 and the common electrode 330. As a result, transmittance of light emitted from the backlight unit 100 is adjusted.

The second substrate 12 of the liquid crystal panel 10 includes black matrices 310 that are formed on a second insulating substrate 300 to prevent light leakage. The second substrate 12 further includes a color filter 320 that is formed corresponding to pixel areas divided by the black matrices 310 and the common electrode 330 formed on the color filter 320.

In an exemplary embodiment of the present invention, the black matrices 310 of the second substrate 12 include opaque metal or opaque organic/inorganic material. The black matrices 310 are formed corresponding to the gate lines 210, data lines 280 and thin film transistors 250, which are formed on the first substrate 11 of the liquid crystal panel 10. Accordingly, the black matrices 310 prevent light leakage.

In an exemplary embodiment of the present invention, the common electrode 330 of the second substrate 12 includes transparent conductive material such as indium tin oxide (“ITO”), indium zinc oxide (“IZO”) or indium tin zinc oxide (“ITZO”). If data voltage is supplied to the pixel electrodes 290, the common electrode 330 forms the electric field to drive the liquid crystals 13.

In an exemplary embodiment of the present invention, the color filter 320 is formed by coating RGB color resins on sub-pixel areas divided by the black matrices 310. The color filter 320 comprises different transmission spectra corresponding to RGB color filters.

FIG. 3 shows the liquid crystal panel in which the color filter 320 is formed at the second substrate 12. Alternatively, the color filter 320 may be formed at the first substrate 11 (not shown).

Referring to FIG. 1, the panel driving unit 40 comprises a gate tape carrier package (“TCP”) 22, a data TCP 32 and a circuit substrate 33. In an exemplary embodiment of the present invention, the gate TCP 22 has one side connected with the first substrate 11 of the liquid crystal panel 10, as shown in FIG. 1, and includes a gate driving circuit 21 which drives the gate lines 210 formed on the first substrate 11 (FIG. 2).

The data TCP 32 has one side connected with the first substrate of the liquid crystal panel 10 and another side connected with the circuit substrate 33, also shown in FIG. 1, and includes a data driving circuit 31 which drives the data lines 280 (FIG. 2). The circuit substrate 33 includes driving elements, for example, timing controllers.

The gate driving circuit 21 and the data driving circuit 31 may be mounted on the first substrate 11 through a chip-on-glass (“COG”) method, or may be installed in the first substrate 11 in the process of forming the thin film transistor.

Referring to FIG. 1, the backlight unit 100 includes a plurality of lamps 80 and an optical sheet section 90. The backlight unit 100 is illustrated with direct-illumination in which the plurality of lamps 80 is aligned. However, exemplary embodiments of the present invention may include various types of backlight units.

The optical sheet section 90 of the backlight unit 100 includes a diffusion sheet, a prism sheet and a protective sheet (not shown).

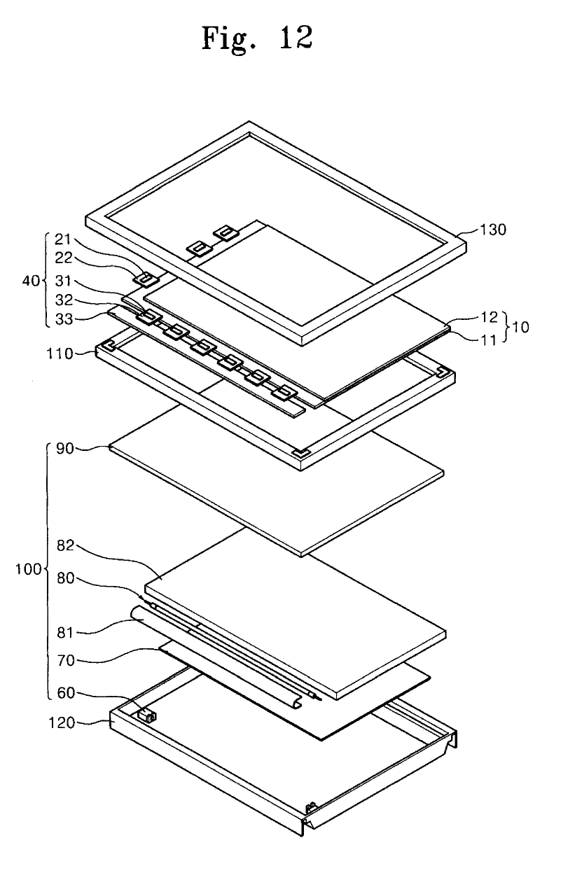

The diffusion sheet widely diffuses light emitted from a light guide plate 82, as shown in FIG. 12, to prevent a bright line and a dark line of the light. In an exemplary embodiment of the present invention, one or two prism sheets may be used to straighten the light diffused by the diffusion sheet. As a result, light having increased brightness is supplied to the liquid crystal panel 10. The protective sheet of the backlight unit 100 may prevent a defect, such as a scratch from occurring in the prism sheet, and prevent static electricity from being generated by movement between the liquid crystal panel 10 and the prism sheet.

The plurality of lamps 80 may be aligned below the optical sheet section 90. Also, the plurality of lamps 80 is fixed to lamp sockets 60. The plurality of lamps receives tube current from inverters and provide light to the liquid crystal panel 10.

In an exemplary embodiment of the present invention, a reflective sheet 70, as shown in FIG. 1, may be aligned below the plurality of lamps 80. The reflective sheet 70 reflects the light, from the plurality of lamps 80 to the liquid crystal panel 10. As a result, light efficiency is improved.

The backlight unit 100 is received in a mold frame 110 and a bottom chassis 120. Further, the liquid crystal panel 10 is disposed in the mold frame 110 and then fixed by a top chassis 130.

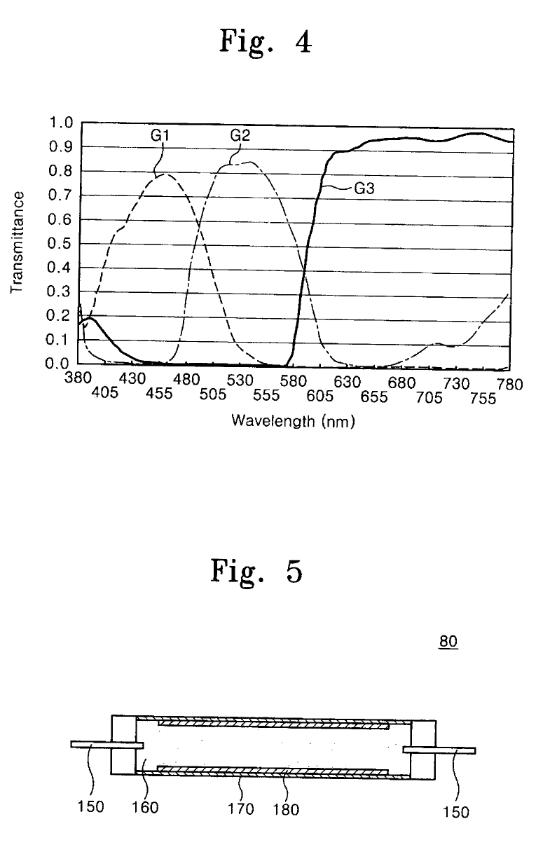

FIG. 4 is a graph illustrating a transmission spectrum of colors of the color filter 320 shown in FIG. 3. In FIG. 4, a horizontal axis denotes wavelength and a vertical axis denotes transmittance.

The color filter 320 comprises a blue color filter G1, a green color filter G2 and a red color filter G3. The blue color filter GI has a transmission spectrum of 400 nm to 530 nm and allows light of a corresponding spectrum to pass therethrough, if white light is incident into the blue color filter. The green color filter G2 has a transmission spectrum of 460 nm to 600 nm and allows light of a corresponding spectrum to pass therethrough, if white light is incident into the green color filter. The red color filter G3 has a transmission spectrum of 580 nm to 800 nm and allows light of a corresponding spectrum to pass therethrough, if white light is incident into the red color filter.

The color filter 320 also comprises a thickness of about 17 μm to about 20 μm. Thus, when the color filter's 320 thickness is about 17 μm or less, or about 20 μm or more, the transmission spectrum according to colors shown in FIG. 4 is varied so that transmittance of the wavelength of the light emitted from the lamps is lowered. As a result, brightness of the light may be reduced.

FIG. 5 is a cross sectional view illustrating the lamp 80 of the backlight unit 100 shown in FIG. 1.

Referring to FIG. 5, the lamp includes a discharge tube 170, lamp electrodes 150, discharge gas 160 and a fluorescent substance layer 180.

In further detail, the discharge tube 170 includes transparent material such as glass and maintains an internal vacuum state. The lamp electrodes 150 are inserted into opposite ends of the discharge tube 170 to provide external tube current to the discharge tube 170.

The discharge gas 160 includes a mixture of Hg, Ne and Ar gases and is filled in the discharge tube 170. The discharge gas 160 receives tube current from the lamp electrodes 150, so that the energy state of the discharge gas is changed from ground state to excited state. Then the discharge gas loses its energy by emitting ultraviolet rays while the energy state is changed from excited state to ground state.

The fluorescent substance layer 180 receives the ultraviolet rays emitted by exciting the discharge gas 160 to generate a visible ray. The fluorescent substance layer 180 includes blue, green and red fluorescent substances, which are disposed on an inner wall of the discharge tube 170.

The blue fluorescent substance may comprise a compound of (Sr, Ca, Ba, Mg)₅(PO4)₃CL:Eu²⁺ (hereinafter, referred to as SCA), and the green fluorescent substance may comprise a compound of BaMaAl₁₀O₁₇:Eu₂₊,Mn²⁺ (hereinafter, referred to as BAM:Mn). The red fluorescent substance may comprise a compound of Y₂O:Eu³⁺ (hereinafter, referred to as YOX) and 3.5MgO.0.5MgF₂.GeO₂:Mn⁴⁺ (hereinafter, referred to as MFG).

The lamp 80, which contains the blue fluorescent substance, the green fluorescent substance and the red fluorescent substance, emits a blue light, green light and red light, respectively. The blue light emitted is output with a peak value at a wavelength of about 445 nm, and the green light is output with a peak value at a wavelength of about 515 nm. The red light is output with two peak values at wavelengths of about 610 nm and about 660 nm. Relative intensity of wavelengths having the two peak values may vary depending on the mixture ratio of (YOX and MFG).

Hereinafter, a relationship between wavelengths and brightness of the red light according to the mixture ratio of the red fluorescent substances will be described with reference to Tables 1 and 2 below.

TABLE 1

| | Phosphor (Portion, %) | | | | | | |
|---|---|---|---|---|---|---|---|
| | Color | | | | | | |
| | BLUE | GREEN | RED | | | Color Gamut | Color Gamut |
| Compound | SCA | BAM:Mn | YOX | MFG | Brightness | (1931) | (1976) |
| 1^{st} | 100% | 100% | 100% | 0% | 100% | 92.0% | 98.1% |
| 2^{nd} | 100% | 100% | 90% | 10% | 98.4% | 93.9% | 101.5% |
| 3^{rd} | 100% | 100% | 80% | 20% | 98.1% | 95.9% | 104.3% |
| 4^{th} | 100% | 100% | 70% | 30% | 97.7% | 97.7% | 106.9% |
| 5^{th} | 100% | 100% | 60% | 40% | 97.4% | 99.5% | 109.4% |

Table 1 shows brightness and color reproducibility according to the mixture ratio of the blue, green and red fluorescent substances. The blue fluorescent substance uses SCA, the green fluorescent substance uses (BAM:Mn) and the red fluorescent substance uses (YOX and MFG).

Table 1 also shows the simulation results obtained by mixing the same amount of the blue, green and red fluorescent substances, in accordance with a percentage of composition weights, while changing the ratio of (YOX and MFG) used for the red fluorescent substance.

As shown in Table 1, referring to the second simulation result (2^{nd}) obtained when the composition ratio of (YOX and MFG) is 9:1, the color reproducibility is increased by about 1.9% in accordance with the CIE1931, as compared with the first simulation result (1^{st}) not having MFG. Further, the color reproducibility is increased by about 3.4% in accordance with the CIE1976 as compared with the first simulation result (1^{st}) not having MFG.

Referring to the third simulation result (3^{rd}) obtained when the composition ratio of (YOX and MFG) is 8:2, the color reproducibility is increased by about 3.9% in accordance with the CIE1931, as compared with the first simulation result (1^{st}) not having MFG. Further, the color reproducibility is increased by about 6.2% in accordance with the CIE1976, as compared with the first simulation result (1^{st}) not having MFG.

Referring to the fourth simulation result (4^{th}) obtained when the composition ratio of (YOX and MFG) is 7:3, the color reproducibility is increased by about 5.7% in accordance with the CIE1931 as compared with the first simulation result (1^{st}) not having MFG. Further, the color reproducibility is increased by about 8.8% in accordance with the CIE1976, as compared with the first simulation result (1^{st}) not having MFG.

Referring to the fifth simulation result (5^{th}) obtained when the composition ratio of (YOX and MFG) is 6:4, the color reproducibility is increased by about 7.5% in accordance with the CIE1931, as compared with the first simulation result (1^{st}) not having MFG. Further, the color reproducibility is increased by about 11.3% in accordance with the CIE1976, as compared with the first simulation result (1^{st}) not having MFG.

In Table 1, if the ratio of MFG is increased, the brightness of the red light may be reduced by about 2% to 3%. The brightness of the red light may be reduced because the average brightness of the red light emitted through (YOX and MFG) is reduced. However, it should be noted that the reduction rate is very low as compared with the increase in the color reproducibility.

TABLE 2
Phosphor (Weight, %)

| Color | | |
|---|---|---|
| BLUE | GREEN | RED |

| Compound | SCA | BAM:Mn | YOX | MFG |
|---|---|---|---|---|
| 1^{st} | 47.5 g | 21.3 g | 31.2 g | 0.0 g |
| 2^{nd} | 46.5 g | 20.5 g | 28.8 g | 4.2 g |
| 3^{rd} | 43.3 g | 20.6 g | 25.1 g | 8.0 g |
| 4^{th} | 46.1 g | 20.8 g | 21.9 g | 11.2 g |
| 5^{th} | 45.8 g | 21.0 g | 18.7 g | 14.5 g |

Table 2 shows the first through fifth simulation results (1^{st}) to (2^{nd}) obtained when using SCA (blue fluorescent substance), (BAM:Mn) (green fluorescent substance) and (YOX and MFG) (red fluorescent substance) in accordance with 100 g of composition weight.

The weight of each fluorescent substance shown in Table 2 may be changed within the range of 5% based on the percentage shown in Table 1. In detail, the weight of the compound of each fluorescent substance may be changed in order to control valance of white light.

Referring to Table 2, SCA of 45 g to 47 g, (BAM:Mn) of 20 g to 21.5 g, YOX of 18 g to 29.5 g, and MFG of 3.5 g to 14.5 g may be mixed.

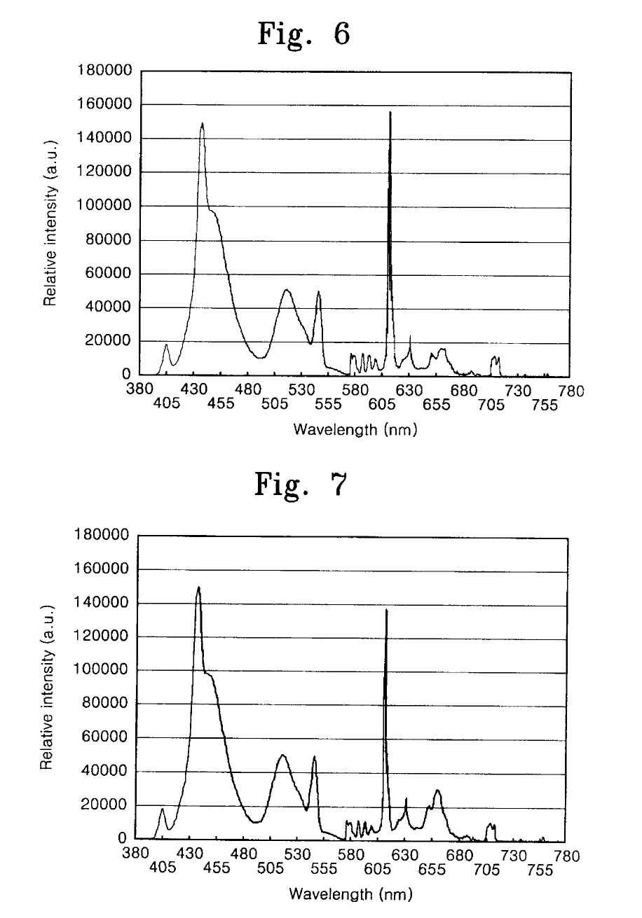

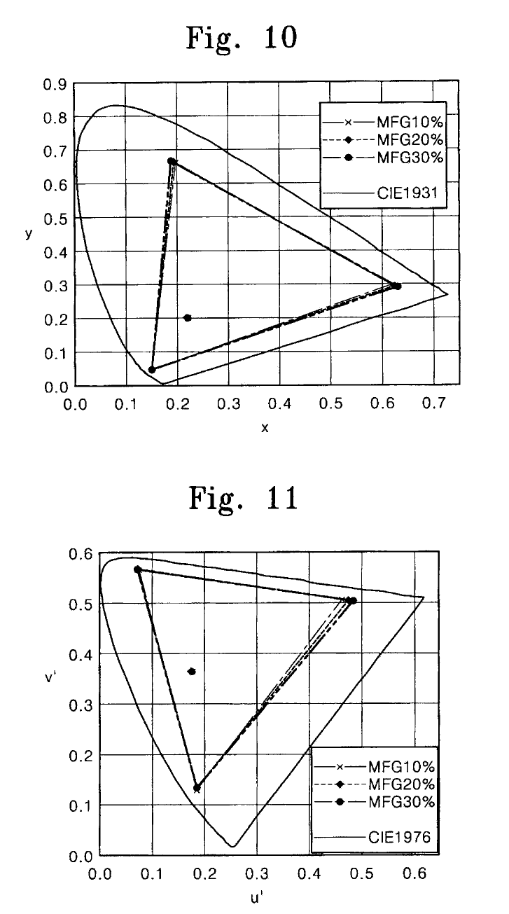

FIGS. 6 to 9 are graphs illustrating the (1^{st}) to (5^{th}) simulation results shown in Tables 1 and 2, FIG. 10 is a graph illustrating the color reproducibility in accordance with the CIE1931, and FIG. 11 is a graph illustrating the color reproducibility in accordance with the CIE1976.

In FIGS. 6 to 9, a horizontal axis denotes wavelength of light output from the lamp, and a vertical axis denotes relative intensity in each wavelength.

As shown in FIGS. 6 to 9, the lamp 80 according to an exemplary embodiment of the present invention generates the blue light, which has a peak value of the relative intensity at a wavelength of 447 μm, and the green light having a peak value of the relative intensity at a wavelength of 515 μm. Further, the relative intensity of two wavelengths of the red light may vary depending on the ratio of (YOX and MFG). The red light emitted by YOX has a peak value of the relative intensity at a wavelength of 600 μm to 620 μm. In addition, the red light emitted by MFG has a peak value of the relative intensity at a wavelength of 650 μm to 670 μm.

FIG. 6 is a graph illustrating the second simulation result (2^{nd}) obtained when YOX has a ratio of 90% and MFG has a ratio of 10%.

As shown in FIG. 6, the relative intensity of the red light obtained when using YOX is 159,000 a.u. Further, the relative intensity obtained when using MFG is 19,000 a.u.

FIG. 7 is a graph illustrating the second simulation result (2^{nd}) obtained when YOX has a ratio of 80% and MFG has a ratio of 20%.

As shown in FIG. 7, the relative intensity of the red light obtained when using YOX is 139,000 a.u. Further, the relative intensity obtained when using MFG is 30,000 a.u.

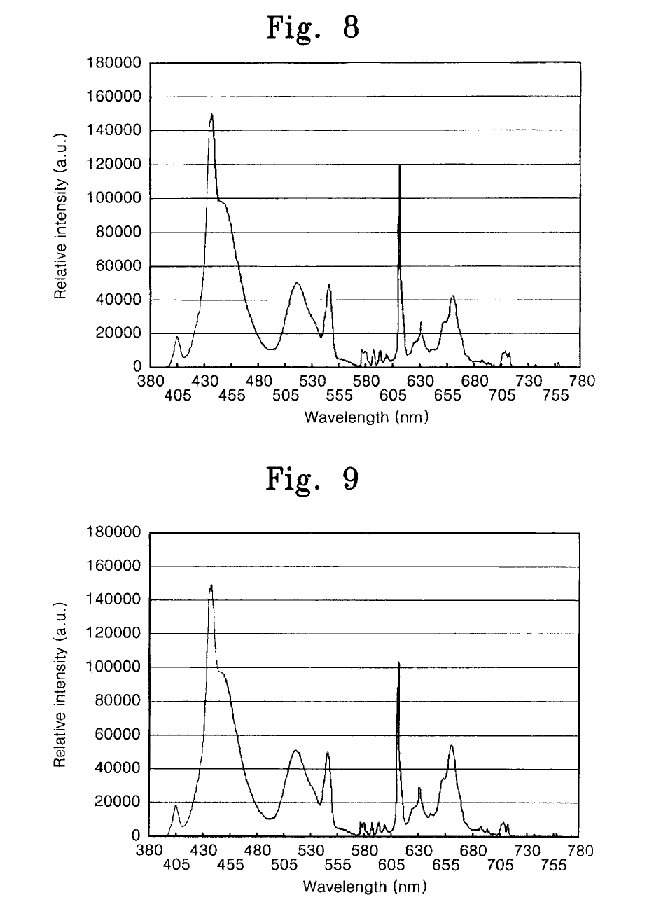

FIG. 8 is a graph illustrating the second simulation result (2^{nd}) obtained when YOX has a ratio of 70% and MFG has a ratio of 30%.

As shown in FIG. 8, the relative intensity of the red light obtained when using YOX is 120,000 a.u. Further, the relative intensity obtained when using MFG is 41,000 a.u.

FIG. 9 is a graph illustrating the second simulation result (2^{nd}) obtained when YOX has a ratio of 60% and MFG has a ratio of 40%.

As shown in FIG. 9, the relative intensity of the red light obtained when using YOX is 111,000 a.u. Further, the relative intensity obtained when using MFG is 58,000 a.u.

When the ratio of YOX is 60% or less and the ratio of MFG is 40% or more, an average value of relative intensity values of the two red lights is reduced so that brightness of the red light may be significantly reduced. Thus, the ratio between YOX and MFG should not exceed (6:4).

As shown in FIGS. 10 and 11, as the content of MFG is increased, the color coordinate moves toward a red color. Thus, the spectrum of the red light is increased, so that the red color can be displayed clearly.

FIG. 12 is an exploded perspective view illustrating an LCD according to another exemplary embodiment of the present invention.

Since the LCD shown in FIG. 12 is substantially identical to the LCD shown in FIG. 1, except for the backlight unit 100, which provides edge-illumination, a description relating to the same elements will be omitted for clarity and conciseness.

Referring to FIG. 12, the backlight unit 100 includes at least one lamp 80 and a light guide plate 82.

In further detail, the lamp 80 includes a mixture of the blue fluorescent substance, the green fluorescent substance, and the red fluorescent substance of (YOX and MFG) as described in FIG. 5, and generates blue light, green light and red light having two peak wavelengths.

In an exemplary embodiment of the present invention, at least one or two lamps 80 may be aligned. Further, a lamp cover 81 may be provided to protect the lamp 80 by surrounding the lamp 80.

The light guide plate 82 provides the liquid crystal panel 10 with light incident from the lamp 80. The light guide plate 82 is provided below the liquid crystal panel 10. In order to improve light collection efficiency of the light guide plate 82 or reduce the number of optical sheets of the optical sheet section 90, prism lines may be formed on the bottom surface or the top surface of the liquid crystal panel 10.

The reflective sheet 70 is disposed below the light guide plate 82 and reflects light to the light guide plate 82, when the light is supplied to the reflective sheet 70 through the light guide plate 82. As a result, the light efficiency is improved.

A flat lamp may also be used, except for the tubular lamp shown in FIGS. 1 and 2. The flat lamp may be disposed below the liquid crystal panel 10 to emit light to the liquid crystal panel 10. The use of the flat lamp may reduce the number of inverters required to drive a plurality of lamps. Moreover, removal of the reflective sheet 70 may reduce manufacturing costs.

According to the lamp and the display device having the lamp, the color reproducibility may be improved by using two types of red fluorescent substances. When the lamp uses two types of red fluorescent substances, the red color of the display device may be clearly displayed.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit and/or scope of the present invention as defined by the following claims.

What is claimed is:

1. A lamp for a backlight unit of a display panel in a display device, the lamp comprising:
a discharge tube;
a discharge gas in the discharge tube; and
a blue fluorescent substance, a green fluorescent substance and a red fluorescent substance disposed on an inner wall surface of the discharge tube to generate a blue light, a green light and a red light, respectively, by ultraviolet rays emitted by the discharge gas,
wherein the red fluorescent substance comprises at least two different red fluorescent substances, which generate the red light having peak wavelengths different from each other.

2. The lamp of claim 1, wherein the red fluorescent substance generates the red light at a wavelength of about 600 μm to about 680 μm.

3. The lamp of claim 2, wherein the red fluorescent substance comprises compounds Y₂O:Eu³⁺ and 3.5MgO.0.5MgF₂.GeO₂:Mn⁴⁺.

4. The lamp of claim 3, wherein the red fluorescent substance comprises the Y₂O:Eu³⁺ having 60% composition weight to 90% composition weight and the 3.5MgO.0.5MgF₂.GeO₂:Mn⁴⁺ having 10% composition weight to 40% composition weight %.

5. The lamp of claim 1, wherein the blue fluorescent substance comprises compound (Sr, Ca, Ba, Mg)₅(PO4)₃CL:Eu²⁺.

6. The lamp of claim 1, wherein the green fluorescent substance comprises compound BaMaAl₁₀O₁₇:Eu2+,Mn²⁺.

7. A display device comprising:
a display panel; and
a backlight unit including at least one lamp to emit light to the display panel,
wherein the lamp comprises:
a discharge tube;
a discharge gas in the discharge tube; and
a blue fluorescent substance, a green fluorescent substance and a red fluorescent substance disposed on an inner wall surface of the discharge tube to generate a blue light, a green light and a red light, respectively, by ultraviolet rays emitted by the discharge gas,
wherein the red fluorescent substance comprises at least two different red fluorescent substances that generate the red light having peak wavelengths different from each other.

8. The display device of claim 7, wherein the display panel comprises:
a first substrate and a second substrate; and
a color filter disposed at the first substrate or the second substrate.

9. The display device of claim 8, wherein the color filter has a thickness of about 1.5 μm to about 2 μm.

10. The display device of claim 9, wherein the color filter comprises:
a blue color filter allowing light having a wavelength range of about 400 nm to about 530 nm to pass therethrough;
a green color filter allowing light having a wavelength range of about 460 nm to about 600 nm to pass therethrough; and
a red color filter allowing light having a wavelength range of about 580 nm to about 800 nm to pass therethrough.

11. The display device of claim 10, wherein the red fluorescent substance generates the red light at a wavelength range of about 600 nm to about 680 nm.

12. The display device of claim 11, wherein the red fluorescent substance comprises compounds Y₂O:Eu³⁺ and 3.5MgO.0.5MgF₂.GeO₂:Mn⁴⁺.

13. The display device of claim 12, wherein the red fluorescent substance comprises the Y₂O:Eu³⁺ having 60% composition weight to 90% composition weight and the 3.5MgO.0.5MgF₂.GeO₂:Mn⁴⁺ having 10% composition weight to 40% composition weight.

14. The display device of claim 10, wherein the blue fluorescent substance comprises compound (Sr, Ca, Ba, Mg)₅(PO4)₃CL:Eu²⁺.

15. The display device of claim 10, wherein the green fluorescent substance comprises compound BaMaAl₁₀O₁₇:Eu₂+,Mn²⁺.

16. The display device of claim 7, wherein the backlight unit comprises a plurality of lamps disposed below the display panel.

17. The display device of claim 16, further comprising:
an optical sheet section disposed between the lamps and the display panel; and
a reflective sheet disposed below the lamps.

18. The display device of claim 7, wherein the backlight unit further comprises a light guide plate disposed below the display panel, and the lamp is disposed at a lateral side of the light guide plate.

19. The display device of claim 18, further comprising:
an optical sheet section disposed between the display panel and the light guide plate; and
a reflective sheet disposed below the light guide plate.

20. A method for generating a light comprising a blue light, green light, a first red light and a second red light in a lamp of a backlight unit, the method comprising:
generating ultraviolet rays by an excited a discharge gas;
emitting the blue light from a blue fluorescent substance using the ultraviolet rays;
emitting the green light from a green fluorescent substance using the ultraviolet rays;
emitting the first red light comprising a first peak wavelength from a first red fluorescent substance;
emitting the second red light comprising a second peak wavelength from a second red fluorescent substance; and
emitting the light from the lamp,
wherein the first peak wavelength and the second peak wavelength are different from each other.
